(19) United States
(12) Patent Application Publication
(10) Pub. No.: US 2009/0100839 A1
(43) Pub. Date: Apr. 23, 2009

(54) COMBUSTION CHAMBER WALL WITH OPTIMIZED DILUTION AND COOLING, AND COMBUSTION CHAMBER AND TURBOMACHINE BOTH PROVIDED THEREWITH

(75) Inventors: Michel Pierre Cazalens, Bourron Marlotte (FR); Patrice Andre Commaret, Rubelles (FR); Romain Nicolas Lunel, Montereau Sur le Jard (FR)

Correspondence Address: OBLON, SPIVAK, MCCLELLAND MAIER & NEUSTADT, P.C., 1940 DUKE STREET, ALEXANDRIA, VA, 22314, US

(73) Assignee: SNECMA, Paris (FR)

(21) Appl. No.: 12/255,987

(22) Filed: Oct. 22, 2008

(30) Foreign Application Priority Data
Oct. 22, 2007 (FR) 07 07360

(51) Int. Cl. F23R 3/06; F02C 7/18

(52) U.S. Cl. 60/754; 415/116

(57) ABSTRACT

The invention applies to the field of turbomachines and relates to a combustion chamber in which the supply of dilution air and cooling air is optimized. The invention is concerned more particularly with optimizing the position of the dilution holes present on the walls of the combustion chamber.

The invention applies to the field of turbomachines and relates to a combustion chamber in which the supply of dilution air and cooling air is optimized.

The invention is concerned more particularly with optimizing the position of the dilution holes present on the walls of the combustion chamber.

In the remainder of the description, the terms “upstream” or “downstream” will be used to denote the positions of the structural elements with respect to one another in the axial direction, taking the gas flow direction as reference point. Likewise, the terms “internal” or “radially internal” and “external” or “radially external” will be used to denote the positions of the structural elements with respect to one another in the radial direction, taking the axis of rotation of the turbomachine as reference point.

A turbomachine comprises one or more compressors which deliver pressurized air to a combustion chamber where the air is mixed with fuel and ignited so as to generate hot combustion gases. These gases flow downstream of the chamber towards one or more turbines which convert the energy thus received in order to rotate the compressor or compressors and provide the energy required, for example, to power an aircraft.

Typically, a combustion chamber used in aeronautics comprises an internal wall and an external wall which are interconnected at their upstream end by a chamber endwall. The chamber endwall has, spaced circumferentially, a plurality of openings each accommodating an injection device which allows the mixture of air and fuel to be fed into the chamber.

The combustion chamber is supplied with liquid fuel mixed with air from a compressor. The liquid fuel is fed to the chamber by injectors in which the fuel is vaporized into fine droplets. This fuel is then burned within the combustion chamber, thereby making it possible to raise the temperature of the air coming from the compressor.

In general, a combustion chamber must satisfy a number of demands and is dimensioned accordingly. It must first of all allow the fuel to be used optimally, that is to say to achieve the highest possible combustion efficiencies. It must furthermore provide the turbine with hot gases whose temperature distribution at the chamber outlet must not only be compatible with the reliability required but also be as uniform as possible. Moreover, it must degrade the flow energy to the least possible extent, and hence generate a minimal pressure drop between its inlet and its outlet. The parts making up the combustion chamber must finally have good mechanical stability, which means that it is necessary to reduce the temperature of the walls of the chamber.

Inside the chamber, the combustion takes place in two principle phases, with two zones physically corresponding to these phases. In a first zone, also termed primary zone, the air/fuel mixture is in stoichiometric proportions or close to these proportions. To produce the air/fuel mixture, the air is injected simultaneously in the region of the injectors and the chamber endwall and also across the walls of the chamber through a first row of orifices, termed primary holes. Having a mixture in stoichiometric or close-to-stoichiometric conditions within the primary zone makes it possible to obtain good combustion efficiency with a maximum reaction rate. Reaction rate refers to the rate of disappearance of one of the constituents of the air/fuel mixture. Moreover, to ensure that combustion is complete, the air/fuel mixture must dwell for a sufficient length of time in this primary zone. The temperature reached by the gases obtained from the combustion in the primary zone is very high. It may, for example, reach 2000° C., a temperature which is incompatible with the good mechanical stability of the materials constituting the turbine and the chamber. It is therefore required to cool these gases, something which is carried out in a second zone. Generally, the primary zone represents approximately the first third of the length of the chamber.

In the second zone, also termed dilution zone, fresh air, termed dilution air, from the compressor is injected into the chamber across its walls by way of orifices, termed dilution holes. The dilution air makes it possible to cool the gases obtained from the combustion along with the walls of the chamber. Moreover, the dilution air as it cools the gases makes it possible to stop the chemical combustion reaction.

The high temperatures reached by the gases during the combustion make it necessary to cool the walls of the chamber in a specific manner. Various cooling techniques exist, such as forced convection in which the cooling is provided by circulating air from the compressor around the chamber, or else air-film cooling in which a film of fresh air from the compressor is interposed between the walls of the chamber and the gases. Another cooling method is that of multiperforation. This technique involves a multitude of orifices of very small diameter, generally in the order of approximately 0.6 mm, being formed over all or part of the walls of the chamber. The fresh air circulating around the chamber enters the latter through these orifices. The walls are then cooled both by convection inside the orifices and by film since this air then sweeps the internal face of the walls. This technique offers the advantage of being able to act locally on any hot spots which may exist on the walls of the chamber.

Thus, when it is necessary to cool a specific zone of the walls of the chamber, it is known practice to locally adjust the multiperforation, for example by increasing the density of orifices.

All the primary holes on the one hand and all the dilution holes on the other hand are respectively arranged at the same axial position with respect to the chamber endwall, the dilution holes being situated downstream of the primary holes. The axial positions of the primary holes and the dilution holes, and in particular the distance in the axial direction between the primary and dilution holes, and also the distributions thereof over the circumference of the walls of the chamber, constitute important parameters on which the designer acts in order to modify the temperature distribution at the chamber outlet and to reduce polluting emissions.

The relative positioning of the dilution holes and the multiperforation orifices has a direct impact on the cooling of those zones of the chamber walls situated directly downstream of the dilution holes.

In the case of certain chambers, the dilution holes do not all have the same diameter, with the aim of improving the temperature distribution at the chamber outlet. In this case, if the walls of the chamber are cooled by means of multiperforation orifices, the distance between these orifices and the small-diameter dilution holes is greater than the distance between the multiperforation orifices and the large-diameter dilution holes. This may be the source of hot spots on the chamber walls that are detrimental to the mechanical stability and the service life of the walls. These hot spots do not occur when the chamber is cooled by a film of air flowing along the internal side of its walls.

The aim of the invention is to provide a simple solution which can be implemented easily and which, in the case of the walls of the chamber being cooled by multiperforation, makes it possible to avoid the occurrence of any hot spots without increasing polluting emissions or having a negative impact on the temperature distribution at the chamber outlet.

The invention makes it possible to solve this problem by providing a new definition of the position of the dilution holes on the walls of the chamber.

More specifically, the invention relates to a turbomachine combustion chamber wall comprising at least one circumferential row of primary holes, at least one circumferential row of dilution holes, and multiperforation orifices, the primary holes all being situated at the same axial position, the primary holes and the dilution holes being uniformly distributed over the circumference of the wall, the dilution holes being divided into at least two separate groups according to the value of their diameter, one fraction of the dilution holes having the largest diameter, another fraction of dilution holes having the smallest diameter, the multiperforation orifices having diameters which are less than the smallest diameter of the dilution holes, this chamber wall being noteworthy in that, with the dilution holes having the largest diameter and the dilution holes having the smallest diameter being provided with a downstream edge and the multiperforation orifices being provided with an upstream edge, the dilution holes having the smallest diameter are offset axially downstream with respect to the dilution holes having the largest diameter, the downstream edge of the small-diameter dilution holes being circumferentially aligned with the downstream edge of the dilution holes having the largest diameter.

Advantageously, with the multiperforation orifices situated immediately downstream of the dilution holes forming a first circumferential row of orifices situated at the same axial distance, and with the downstream edge of the dilution holes having the smallest diameter and the upstream edge of the multiperforation orifices of the first circumferential row being axially distant by a value D2, D2 is less than or equal to double the diameter of the multiperforation orifices of the first row.

Preferably, the dilution holes having the smallest diameter are axially aligned with the primary holes.

The invention further relates to a combustion chamber and to a turbomachine provided with at least one such wall.

The invention will be better understood and other advantages thereof will become more clearly apparent in the light of the description of a preferred embodiment and of variants that is given by way of non-limiting example with reference to the appended drawings, in which:

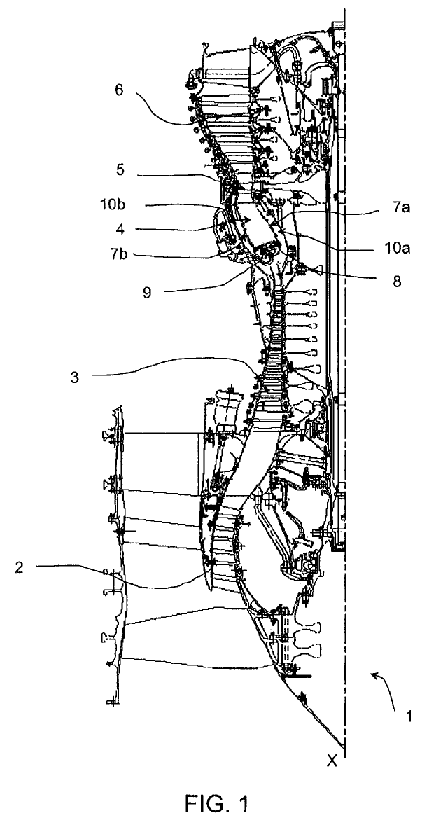

FIG. 1 is a schematic partial view in section of a turbomachine, more precisely an aircraft jet engine;

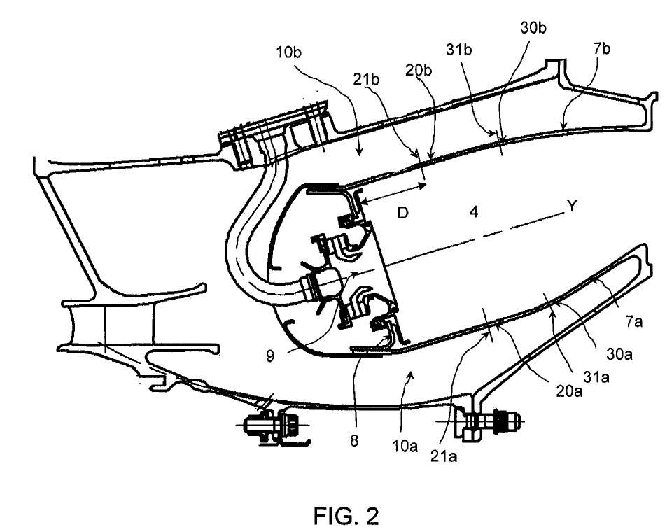

FIG. 2 is a schematic view in section of a combustion chamber according to the prior art;

FIG. 3 is a plan view of an angular sector of the external wall of a combustion chamber according to the prior art;

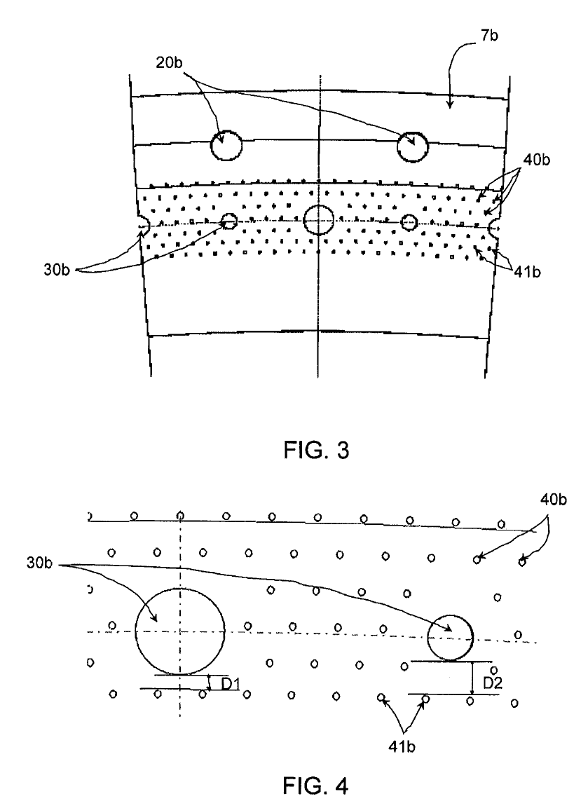

FIG. 4 is a detail view of the angular sector shown in FIG. 3;

FIG. 5 is a plan view of an angular sector of the external wall of a combustion chamber according to the invention; and

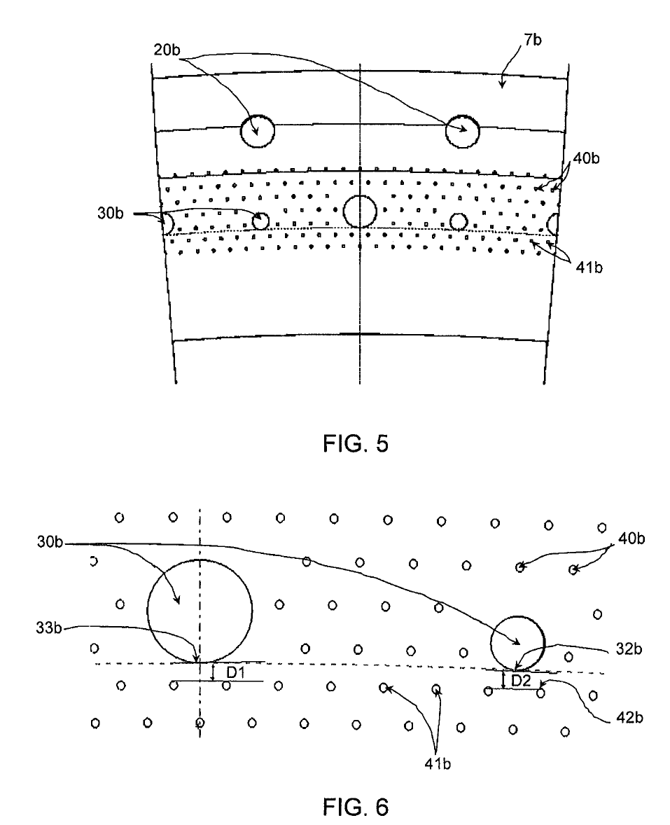

FIG. 6 is a detail view of the angular sector shown in FIG. 5.

FIG. 1 shows, in section, an overall view of a turbomachine 1, for example an aircraft jet engine, whose axis of rotation is designated X. The turbomachine 1 comprises a low-pressure compressor 2, a high-pressure compressor 3, a combustion chamber 4, a high-pressure turbine 5 and a low-pressure turbine 6. The combustion chamber 4 is of the annular type and is bounded by an annular internal wall 7a and an annular external wall 7b which are spaced apart radially with respect to the axis X and connected at their upstream end to an annular chamber endwall 8. The chamber endwall 8 comprises a plurality of openings which are uniformly spaced circumferentially. In each of these openings is mounted an injection device 9. The combustion gases flow in the downstream direction in the combustion chamber 4 and then supply the turbines 5 and 6, which respectively drive the compressors 3 and 2, arranged upstream of the chamber endwall 8, via two shafts respectively. The high-pressure compressor 3 supplies air to the injection devices 9 and also to two annular spaces 10a and 10b arranged radially one on the inside and one on the outside of the combustion chamber 4. The air introduced into the combustion chamber 4 contributes to vaporizing the fuel and to its combustion. The air circulating outside the walls of the combustion chamber 4 contributes, on the one hand, to combustion and, on the other hand, to cooling the walls 7a and 7b and the gases obtained from the combustion. For that purpose, the air enters the chamber respectively through a first row of orifices, termed primary holes, and through a second series of orifices, termed dilution holes, and also through multiperforation orifices formed on the internal wall 7a and external wall 7b. These various orifices are represented in FIGS. 2 and 3.

FIG. 2 shows more precisely a section through a combustion chamber 4 according to the prior art.

The internal wall 7a and external wall 7b of the chamber 4 are both provided with a row of primary holes 20a and 20b respectively, the axes of which are designated 21a and 21b respectively. Arranged downstream of these primary holes 20a, 20b is a row of dilution holes 30a, 30b, the axes of which are designated 31a and 31b respectively. On the internal wall 7a, all the primary holes 20a are situated at the same distance D from the chamber endwall 8. The same applies to the dilution holes 30a and also to the primary holes 20b and dilution holes 30b on the external wall 7b.

FIG. 3 shows a plan view of an angular sector of the external wall 7b of the combustion chamber 4 according to the prior art. On this sector can be seen two of the primary holes 20b and also a number of dilution holes 30b. All the primary holes have the same diameter, whereas the dilution holes may, as illustrated here, have different diameters. The primary holes 20b are uniformly distributed over the circumference of the external wall 7b. The dilution holes for their part are also uniformly distributed over the circumference of the external wall 7b. For each primary hole 20b a dilution hole 30b is arranged at the same angular position, that is to say that, along the axis Y of the chamber, each primary hole is aligned with a dilution hole 30b. In the case represented in FIG. 3, the dilution holes 30b with the smallest diameter are aligned with the primary holes 20b. The other dilution holes, namely those with the largest diameter, are inserted between the small-diameter dilution holes and arranged at an equal distance therefrom. The large-diameter dilution holes are likewise situated at an equal distance from the nearest primary holes 20b. In the example represented, there is only one small-diameter dilution hole situated angularly between two consecutive large-diameter dilution holes, but there could be a plurality thereof uniformly distributed over the circumference of the external wall 7b.

In order to cool the wall 7b, multiperforation orifices 40b are formed over its whole circumference. The multiperforation orifices 40b generally all have the same diameter, but they could have different diameters, for example according to the zones to be cooled. In the example illustrated here, they are uniformly distributed and form successive rows of orifices arranged at the same axial position. Local adjustments, such as an increase in the number of orifices, could be contemplated. The positioning of the first row 41b of multiperforation orifices 40b situated immediately downstream of the dilution holes 30b is important since it has a direct impact on the temperature reached by the wall 7b in this zone.

FIG. 4 represents a detail view of the angular sector in FIG. 3, showing the dilution holes 30b and also the multiperforation orifices 40b. This view shows that, given the difference in diameter between the dilution holes 30b, the distance along the axis Y of the chamber between a large-diameter dilution hole and the first row of multiperforation orifices 41b, designated D1, is less than the axial distance between a small-diameter dilution hole and the same row of multiperforation orifices, designated D2. This arrangement may result in hot spots downstream of the small-diameter dilution holes that are detrimental to the mechanical stability of the wall 7b and hence to its service life.

FIG. 5 shows a plan view of an angular sector of the external wall 7b of a combustion chamber 4 according to the invention, and FIG. 6 shows an enlargement of this sector. On this sector can be seen two of the primary holes 20b and also a number of dilution holes 30b. The position of the primary holes 20b remains unchanged in relation to the prior art, with only the positioning of the dilution holes 30b being changed. The dilution holes 30b are uniformly distributed over the circumference of the external wall 7b and have different diameters. In our example can be seen small-diameter and large-diameter dilution holes 30b. The small-diameter dilution holes are arranged so as to be aligned with the primary holes 20b, that is to say that they are at the same angular position. The large-diameter dilution holes are arranged between the primary holes 20b, at an equal distance from the nearest small-diameter dilution holes. Multiperforation orifices 40b are formed over the whole circumference of the wall 7b. The multiperforation orifices 40b generally all have the same diameter, but they could have different diameters. Their diameter is much less than the diameter of dilution holes and is generally in the order of approximately 0.6 mm. They are uniformly distributed and they form a succession of rows of orifices in the axial direction. By contrast with the prior art, the dilution holes are no longer all situated at the same axial distance from the primary holes 20b. The small-diameter dilution holes are offset in the downstream direction of the wall 7b, and are thus nearer the first row of multiperforation orifices 41b that is situated immediately downstream of the dilution holes 30b. Thus, that zone of the wall 7b situated between the small-diameter dilution holes and this first row of multiperforation orifices 41b is better cooled, thereby avoiding any hot spots.

In order to avoid disturbing the combustion process, the small-diameter dilution holes must not be offset axially in the downstream direction to an excessive extent. More precisely, the axial distance D2, between the downstream edge 32b of the small-diameter dilution holes and the upstream edge 42b of the multiperforation orifices of the first row 41b, must not be less than the axial distance D1, between the downstream edge 33b of the large-diameter dilution holes and the upstream edge of the multiperforation orifices of the first row 41b. Moreover, in order to ensure good cooling of the wall 7b immediately downstream of the dilution holes, D2 must be less than or equal to double the diameter of the multiperforation orifices of the first row 41b.

Such an arrangement makes it possible to avoid the hot spots which could exist downstream of the dilution holes, without modifying the characteristics of the combustion, in particular without reducing the combustion efficiency or increasing the polluting emissions, and without modifying the temperature distribution at the combustion chamber outlet.

Although the description above has been given by taking the external wall 7b as an example of application, the invention applies equally well and in the same way to the internal wall 7a.

1. Turbomachine combustion chamber wall comprising at least one circumferential row of primary holes, at least one circumferential row of dilution holes, and multiperforation orifices, the primary holes all being situated at the same axial position, the primary holes and the dilution holes being uniformly distributed over the circumference of the wall, the dilution holes being divided into at least two separate groups according to the value of their diameter, one fraction of the dilution holes having the largest diameter, another fraction of dilution holes having the smallest diameter, the multiperforation orifices having diameters which are less than the smallest diameter of the dilution holes, wherein, with the dilution holes having the largest diameter and the dilution holes having the smallest diameter being provided with a downstream edge and the multiperforation orifices being provided with an upstream edge, the dilution holes having the smallest diameter are offset axially downstream with respect to the dilution holes having the largest diameter, the downstream edge of the small-diameter dilution holes being circumferentially aligned with the downstream edge of the dilution holes having the largest diameter.

2. Combustion chamber wall according to claim 1, wherein, with the multiperforation orifices situated immediately downstream of the dilution holes forming a first circumferential row of orifices situated at the same axial distance, and with the downstream edge of the dilution holes having the smallest diameter and the upstream edge of the multiperforation orifices of the first circumferential row being axially distant by a value D2, D2 is less than or equal to double the diameter of the multiperforation orifices of the first row.

3. Combustion chamber wall according to claim 1, wherein the dilution holes having the smallest diameter are axially aligned with the primary holes.

4. Turbomachine combustion chamber comprising at least one wall according to claim 1.

5. Turbomachine provided with a combustion chamber according to claim 4.
